(19) United States
(12) Patent Application Publication
(10) Pub. No.: US 2011/0236703 A1
(43) Pub. Date: Sep. 29, 2011

(54) Coated Metallized Films and Their Method of Manufacture

(76) Inventor: Dennis E. McGee, Penfield, NY (US)

(21) Appl. No.: 13/120,880

(22) PCT Filed: Sep. 9, 2009
(86) PCT No.: PCT/US2009/056355

§ 371 Date: May 2, 2011

Related U.S. Application Data
(60) Provisional application No. 61/108,351, filed on Oct. 24, 2008.

(51) Int. Cl. B32B 15/082; B05D 1/36; B05D 1/38; B05D 3/04; B05D 3/08; B05D 3/10; B32B 15/04

(52) U.S. Cl. 428/463; 427/404; 427/537; 427/225; 427/224; 427/322; 427/343; 428/457; 428/461

(57) ABSTRACT

Provided is a method of preparing a film including the steps of providing a polymer substrate, depositing a metal layer on the polymer substrate in a metallization chamber, removing the metallized film from the metallization chamber, and applying a topcoat to said metal layer within 1 week of depositing the metal layer on the polymer substrate. A film produced by such a method exhibits improved barrier properties, such as improved water-vapor transmission rates.

### CROSS-REFERENCE TO RELATED APPLICATIONS

This application claims priority from U.S. Provisional Application Ser. No. 61/108,351, filed Oct. 24, 2008, the contents of which are incorporated by reference in their entirety.

### FIELD OF THE INVENTION

This disclosure relates to metallized polymer films. More particularly, this disclosure relates to metallized polyolefin film structures which have been coated and have improved barrier properties, such as reduced water vapor transmission rates.

### BACKGROUND OF THE INVENTION

Metallized polymer films are useful for packaging applications in general, and food packaging applications in particular. For example, metallized oriented polypropylene films and metallized oriented high-density polyethylene films exhibit improved food packaging properties, such as low light, oxygen, and water-vapor transmission properties, in comparison to unmetallized films. Additionally, packages made from metallized films may possess improved aesthetics due to their rich, metal-like appearance.

Typically, metallized films are formed by vacuum depositing a thin layer, e.g., from about 100 Å to about 600 Å thick, of a metal, such as aluminum, onto the surface of a base film substrate. The deposited aluminum layer is particularly sensitive to damage, such as scratching, pinholes, and/or pickoff; and any damage to the aluminum layer may result in a deleterious effect on both the film's barrier properties and aesthetic properties.

To protect metallized films from damage, metallized surfaces of films have been covered by adhesive or polymount laminations. The barrier properties of such laminations are often not significantly improved as compared to un-laminated metallized films, and scratching of the metallized surface or stretching the metallized web during the lamination process often degrades the barrier properties of the metallized web. Furthermore, laminations may exhibit peeling wherein the laminated layer peels off of the metallized layer.

Another way of protecting metallized films from damage involves a technique called “in-chamber coating,” wherein coatings are applied in the metallization chamber. However, such “in-chamber” coating methods can be very complex and expensive. Additionally, there are limitations on the types of coatings that can be applied inside a vacuum metallization chamber.

A further way of protecting metallized films involves transferring a “protective layer” onto the film's metal surface inside the metallization chamber. The protective layer is transferred from the other side of the multilayer film to the metallized side during a post-metallization winding and unwinding process, such as the process described in U.S. Pat. No. 7,279,061. Because the protective layer is debonded from the film and then rebound to the metallized surface, peeling may result. Additionally, this process requires a special metallization chamber that allows for winding and un-winding within the metallizer.

Therefore, a need exists for a way to protect metallized films, so that the films can retain their appearance and barrier properties. Preferably the metallized films can be produced using conventional metallizers and conventional coating equipment. It has been found that coating a recently metallized film outside of the metallization chamber not only provides a protective layer for the metallized surface, but that the “out-of chamber” coating step surprisingly improves the film's barrier properties beyond what would be expected by the addition of a coating layer. Moreover, such coated metallized films retain their enhanced barrier properties over time.

### SUMMARY OF THE INVENTION

In one aspect, this disclosure relates to a method of preparing a film comprising the steps of providing a polymer substrate, depositing a metal layer on the polymer substrate in a metallization chamber, removing the metallized film from the metallization chamber, and applying a topcoat to said metal layer within 1 week of depositing the metal layer on the polymer substrate.

In one embodiment, and in combination with the above disclosed aspect, the method further comprises the step of applying a primer to said metal layer prior to applying said topcoat.

In another embodiment, and in combination with any of the above disclosed aspects or embodiments, the method further comprises the step of storing the metallized film in an inert atmosphere prior to applying the coating. The inert atmosphere may have an oxygen content selected from less than 20.9% oxygen, less than 17% oxygen, less than 15% oxygen, less than 10% oxygen, and less than 5% oxygen.

In one embodiment, and in combination with any of the above disclosed aspects or embodiments, the topcoat is applied to the metal layer within a time period selected from the group consisting of three (3) days, one (1) day, 12 hours, six (6) hours, three (3) hours, one (1) hour, and 30 minutes.

In another aspect, this disclosure relates to films made by any of the above disclosed aspects or embodiments. The film may have a water-vapor transmission rate that is more than 30% less than the water-vapor transmission rate of a coated metallized film that was coated more than 30 days after being metallized.

In one embodiment, and in combination with any of the above disclosed aspects or embodiments, the film has a water-vapor transmission rate that is 80% or less than the water-vapor transmission rate of a film comprising the same polymer substrate and metal layer.

In one embodiment, and in combination with any of the above disclosed aspects or embodiments, the metal layer of the film comprises 40% or less aluminum oxide.

These and other features, aspects, and advantages of the present disclosure will become better understood with regard to the following description and appended claims.

### DETAILED DESCRIPTION OF THE INVENTION

Various specific embodiments, versions and examples of the invention will now be described, including preferred embodiments and definitions that are adopted herein for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

As used herein, “substantially free” is defined to mean that the referenced film layer is largely, but not necessarily wholly, absent a particular component. In some embodiments, the layer is completely free of the particular component, however, in other embodiments, small amounts of the component may be present within the referenced layer as a result of standard manufacturing methods, including recycling of film scraps and edge trim during processing.

Disclosed herein are metallized multilayer film structures. The multilayer film structure comprises a polymer substrate, a metal layer, and a topcoat layer, wherein the metal layer is intermediate the polymer substrate and the topcoat layer. In some embodiments, the multilayer film structure further comprises a primer layer intermediate the metal layer and the topcoat layer.

The polymer substrate may be a single layer film or a multilayer film. In some embodiments, the polymer substrate is a multilayer film that comprises a core layer, one or more optional tie layers, and one or more skin layers. For example, in one embodiment the polymer substrate is a multilayer film that comprises a core layer, a tie layer, and a metal-receiving skin layer, wherein the tie layer is intermediate the core layer and the metal-receiving skin layer. In another embodiment, the polymer substrate is a 5-layer film that comprises a core layer, a first and second tie layer, and a heat sealing skin layer and a metal-receiving skin layer, wherein the first tie layer is intermediate the core layer and the heat sealing skin layer and the second tie layer is intermediate the core layer and the metal-receiving skin layer. In embodiments where the polymer substrate comprises a metal-receiving skin layer, it is preferred that the metal layer of the multilayer film structure is deposited on the metal-receiving skin layer of the polymer substrate.

The polymer substrate may comprise any film-forming polymer. The topcoat may comprise an acrylic coating, ethylene acrylic acid (“EAA”) coating, ethylene methacrylic acid (“EMA”) coating, acrylonitrile coating, polyvinylidene chloride (“PVdC”) coating, a polyvinyl alcohol (“PVOH”) coating, ethylene(vinyl)alcohol (“EVOH”), styrene-butadiene (“SBR”) coating, urethane coating, epoxy coating, or blends thereof. The metal layer may comprise at least one of aluminum, gold, silver, chromium, tin, copper, or combinations thereof. In embodiments where the multilayer film structure further comprises a primer layer, the primer may comprise at least one of acrylic, EAA, EMA, polyethylene imine, urethane, epoxy, or blends thereof.

One or both of the outer exposed surfaces of the polymer substrate, primer layer, and/or multilayer film structure may be surface-treated to increase the surface energy of the film. Surface treatments may aid in rendering the film receptive to metallization, coatings, printing inks, and/or lamination. The surface treatment can be carried out according to any method known in the art. Preferred methods include, but are not limited to, corona discharge, flame treatment, plasma treatment, chemical treatment, or treatment by means of a polarized flame.

Disclosed herein are methods for preparing coated metallized films. The method comprises the steps of providing a polymer substrate, depositing a metal layer on the polymer substrate in a metallization chamber, removing the metallized film from said metallization chamber, and applying a coating layer on said metal layer. In preferred embodiments, the coating layer is applied to the metal layer as soon as possible after removing the metallized film from the metallization chamber, such as within a time period selected from any one of the following: within one (1) week, or within three (3) days, or within two (2) days, or preferably within one (1) day, or more preferably within 18 hours, or more preferably within 10 hours, or within five (5) hours, or within three (3) hours, or within one (1) hour, or within thirty minutes of removing the metallized film from the metallization chamber.

In one embodiment, the method further comprises the step of storing the metallized film in an inert atmosphere before applying the coating layer onto the metallized film. Preferably the inert atmosphere is one which will not react with the metal in the metal layer of the film. For example, in one embodiment the inert atmosphere may comprise nitrogen or a noble gas. In another embodiment, the inert atmosphere is one that contains less oxygen than air, such as less than 20.9% oxygen, or less than 17% oxygen, or less than 15% oxygen, or less than 10% oxygen, or less than 5% oxygen, or less than 3% oxygen, or less than 1% oxygen.

Not intending to be bound by any theory, it is believed that metallized films may tend to oxidize to some degree upon exposure to the atmosphere when removed from the metallization chamber. It is believed that the thickness of the aluminum oxide may increase to some finite limit over time while the thickness of the pure aluminum gradually decreases. Therefore, applying a coating layer to the metal layer as soon as possible after metallization may slow down or halt the oxidation of the metal, allowing the aluminum layer to undergo less oxidation than the degree of oxidation that would take place in the standard manufacture of metallized film. This reduced oxidation of the aluminum layer can result in an aluminum layer of higher purity which can provide better barrier properties for a given amount of aluminum deposited. Thus, films that are coated as soon as possible after metallization can have improved water-vapor transmission rates over a period of time as compared to uncoated metallized films.

In some embodiments, the coated metallized multilayer film structure has a water-vapor transmission rate that is 0.9 times (90%) the water-vapor transmission rate (“WVTR”) of the same uncoated metallized multilayer film structure. The coated metallized multilayer film structure may have a WVTR that is 0.8 times (80%) the WVTR of the same uncoated metallized multilayer film structure. In some embodiments, the coated metallized film has a WVTR that is less than 75% of, or less than 60% of, or less than 50% of, or preferably less than 45% of, or less than 40% of, or less than 35% of the WVTR of the same metallized film structure that is uncoated.

In other embodiments, the metallized films prepared according to the method of this disclosure have a WVTR that is at least 10% lower than the WVTR of a coated metallized film that was coated more than 30 days from the metallization step. The metallized film prepared according to the method of this disclosure may have a WVTR that is at least 20% less, or 30% less, or 40% less, or 45% less, or 50% less, or 55% less than the WVTR of a coated metallized film that was coated more than 30 days after being metallized.

In some embodiments, the metallized films prepared according to the method of this disclosure exhibit improved WVTR as compared to the WVTR of a coated metallized film that was coated more than one week from the metallization step. The WVTR of the film prepared according to the method of this disclosure may be 10% less, or 20% less, or 30% less, or 40% less, or 45% less, or 50% less, than the WVTR of a coated metallized film that was coated more than one week after being metallized.

As the coatings are applied to freshly metallized film structures or recently metallized films (e.g., they are coated within 30 days of being metallized), the metal layer of the multilayer film structure contains more aluminum than aluminum oxide. In one embodiment, the metal layer comprises less than 50% aluminum oxide, or less than 40% aluminum oxide, or less than 35% aluminum oxide, or less than 25% aluminum oxide, or less than 15% aluminum oxide, or less than 10% aluminum oxide, or less than 5% aluminum oxide, or less than 3% aluminum oxide. In one embodiment, the metal layer is substantially free of aluminum oxide.

One or more layers of the polymer substrate and/or multilayer film structure may further contain one or more additives. Examples of useful additives include, but are not limited to, opacifying agents, pigments, colorants, cavitating agents, slip agents, antioxidants, anti-fog agents, anti-static agents, anti-block agents, moisture barrier additives, gas barrier additives, hydrocarbon resins, hydrocarbon waxes, fillers such as calcium carbonate, diatomaceous earth and carbon black, and combinations thereof. Such additives may be used in effective amounts, which vary depending upon the property required. For example, the topcoat layer may contain a dispersed wax such as a carnauba or microcrystalline wax; or may contain particulate materials such as an amorphous silica or talc; or may contain antistatic agents, such as poly(oxyethylene) sorbitan monooleate.

### Polymer Substrate

The metallized multilayer film structure includes a polymer substrate layer. The polymer substrate may be a single-layer film or a multi-layer film. For example, in some embodiments, the polymer substrate may comprise a core layer, one or more skin layers on either side of the core layer, and/or one or more tie layers disposed between the core layer and the one or more skin layers.

The polymer substrate may include any film-forming polyolefin. For example, the polymer substrate may comprise one or more polymers selected from propylene, ethylene, polypropylene, isotactic polypropylene (“iPP”), high crystallinity polypropylene (“HCPP”), ethylene-propylene copolymers, ethylene propylene random copolymer, ethylene-propylene block copolymers, propylene-butene copolymers, ethylene-propylene-butylene terpolymers, high density polyethylene (“HDPE”), medium density polyethylene (“MDPE”), low density polyethylene (“LDPE”), linear low density polyethylene (“LLDPE”), syndiotactic polypropylene (sPP), and combinations thereof. The polymers may be produced by Ziegler-Natta catalyst, metallocene catalyst, or any other suitable means.

In one embodiment, the polymer substrate comprises a LDPE having a density of about 0.926 g/cm³ or less and a melt index (“MI”) of about 7 g/10 min. The MI may be determined by ASTM D1238.

In another embodiment, the polymer substrate comprises a LLDPE having a density in the range of about 0.90 g/cm³ to about 0.94 g/cm³, or more preferably in the range of about 0.910 g/cm³ to about 0.926 g/cm³. The LLDPE may have a melt index in the range of about 1 to about 10 g/10 min, or in the range of 0.5 to 10 g/10 min. The LLDPE may be a copolymer of ethylene and a minor amount of a higher olefin comonomer containing 4 to 10 carbon atoms, such as for example, butene-1, hexene-1, or octene-1.

In yet another embodiment, the polymer substrate comprises a MDPE having a density in the range of about 0.926 to about 0.940 g/cm³.

In a further embodiment, the polymer substrate comprises a HDPE. HDPE is a substantially linear polyolefin having a density of about 0.940 g/cm³ or more, or preferably 0.952 g/cm³ or more. The HDPE may have a density in the range of about 0.952 g/cm³ to about 0.962 g/cm³. The HDPE may have a MI in the range of about 0.2 to about 10.0 g/10 min, or preferably in the range of about 0.5 to about 2.0 g/10 min, and a melting point of in the range of about 130° C. to about 148° C.

The polymer substrate may comprise a syndiotactic polypropylene (“sPP”) having an isotacticity of less than 25%, or less than 15%, or less than 6%. The mean length of the syndiotactic sequences may be greater than 20, or greater than 25.

The film-forming polyolefin may be an iPP which has an isotacticity in the range of about 93% to about 99%, a crystallinity in the range of about 70% to about 80%, and a melting point in the range of about 145° C. to about 167° C.

Polypropylene copolymers, if used in the polymer substrate, may include one or more comonomers. Preferably the comonomer is selected from one or more of ethylene or butene. The propylene is generally present in such co- or terpolymers at greater than 90 wt %.

The polymer substrate may include one or more additives. Examples of useful additives include, but are not limited to, opacifying agents, pigments, colorants, cavitating agents, slip agents, antioxidants, anti-fog agents, anti-static agents, anti-block agents, moisture barrier additives, gas barrier additives, hydrocarbon resins, hydrocarbon waxes, fillers such as calcium carbonate, diatomaceous earth and carbon black, and combinations thereof. Such additives may be used in effective amounts, which vary depending upon the property required. If the polymer substrate is a multilayer film, the additive(s) may be included in any one or more of the layers.

### Core Layer

The polymer substrate may be a multilayer film that has a core layer. The core layer of a multilayered film is commonly the thickest layer and provides the foundation of the multilayer film. The core layer may comprise any film-forming polyolefin such as those described above. For example, in one embodiment the core layer may comprise a high crystallinity polymer, such as high crystalline polypropylene (“HCPP”). A high crystallinity polymer may enable the film to maintain a stiffer modulus despite any softer more flexible polymers contained within the various other film layers, such as in one or more of the tie or skin layers.

The core layer generally has a thickness in the range of about 5 μm to 100 μm, or about 5 μm to 50 μm, or preferably in the range of about 10 μm to 30 μm. In some embodiments, the core layer may have a thickness which is about 75% to about 99% of the total polymer substrate's thickness.

The core layer may further comprise one or more additives. Preferred additives for the core layer include, but are not limited to, hydrocarbon resins, hydrocarbon waxes, opacifying or coloring agents, and cavitating agents.

### Skin Layer(s)

The polymer substrate may be a multilayer film that has one or more skin layers. The skin layer is an optional layer and when present is generally the outermost layer of the multilayer film. If the multilayer film has two skin layers, they are the outermost layers of the polymer substrate and are on opposite sides of the core layer from each other. The skin layer(s) may be contiguous to the core layer, or alternatively may be contiguous to one or more other layers, such as, a tie layer described below.

The skin layer(s) may comprise any film-forming polymer as describe above. The skin-layer polymers may be chosen to provide the film with a desired functionality. For example, one or both of the skin layers may be provided to improve the film's barrier properties, processability, printability, or compatibility for metallization, coating, or lamination to other films or substrates. In some embodiments, the polymer substrate may have two different skin layers to provide different functions. For example, one skin layer may comprise a polymer that provides a printable surface while the second skin layer provides the film with improved processability. In another example, one skin lay may be one that enhances the polymer substrate's compatibility for metallization while the other skin layer allows for heat-sealability.

In one embodiment, the skin layer may comprise a polymer that has a reduced melting temperature as compared to more crystalline polymers in order to provide the multilayer film structure with heat-sealing capability. Suitable sealant skin layer polymers include, but are not limited to: Ziegler-Natta or metallocene catalyzed polymers, polypropylene homopolymers, ethylene-propylene copolymers, propylene-butylene copolymers, ethylene-butylene copolymer, ethylene-propylene-butylene (“EPB”) terpolymers, ethylene vinyl acetate, and blends thereof.

In some embodiments, the skin layer may be chosen in improve the film's coating or printing functions. For coating and printing functions, the skin layer is preferably a copolymer or terpolymer that can be surface treated.

In other embodiments, the skin layer may be chosen to improve the film's compatibility for metallization or improve the film's barrier properties. In one embodiment, the metal receiving skin layer may comprise a film-forming polymer such as a HDPE, PP, PB copolymer, or EVOH. In another embodiment, the metal-receiving skin layer does not comprise a film-forming polyolefin, but instead comprises either a film-forming amorphous polyamide or a film-forming blend of an amorphous polyamide and one or more semicrystalline polyamides.

Examples of suitable amorphous polyamide include, but are not limited to: hexamethylenediamine isophthalamide, hexamethylenediamine isophthalamide/terephthalamide terpolymers, mixtures of 2,2,4- and 2,4,4-trimethylhexamethylenediamine terephthalamide, copolymers of hexamethylene diamine and 2-methylpentamethylenediamine with iso- or terephthalic acids, or blends thereof. The amorphous polyamide of the present invention may be blended with at least one semicrystalline polyamide. The term “semicrystalline polyamide” refers to the traditional semicrystalline nylons, which are generally prepared from lactams or amino acids, such as nylon 6 or nylon 11, or from the condensation of diamines, such as hexamethylene diamine, with dibasic acids, such as succinic, adipic, or sebacic acids.

In the embodiment wherein the metal-receiving skin layer comprises an amorphous polyamide or a blend of an amorphous polyamide and one or more semicrystalline polyamides, the surface of the core layer may be modified by a functionalized material. The functionalized material may be mixed into the core layer itself or applied as a tie layer in between the core layer and the polyamide metal-receiving skin layer. The functionalized material may be a maleic anhydride-modified polyolefin, such as, for example, a maleic anhydride-modified polypropylene or a maleic-anhydride-modified ethylene-propylene copolymer. If the functionalized material is added to the film-forming polyolefin of the core layer, it is generally present in an amount of, for example, less than 10 wt %, e.g. from about 0.5 wt % to about 1.5 wt %, based on the combined weight of the film-forming polyolefin of the core layer and the functionalized material.

The thickness of the skin layer(s) depends upon the intended function of the layer, but is usually in the range of 0.1 to 7 μm, or 0.1 μm to 5 μm, or 0.3 μm to 4 μm, or 0.5 μm to 3 μm, or 0.75 μm to 2 μm. In one embodiment, the thickness of the skin layer(s) may be in the range of about 0.1 μm to 2 μm, or 0.1 μm to 0.5 μm. In another embodiment the skin layer may have a thickness in the range of about 1 to about 20% of the total polymer substrate's thickness, or in the range of about 1 to about 10% of the total polymer substrate thickness.

The skin layer may further comprise one or more additives such as, for example, anti-block agents, anti-static agents, slip agents, and combinations thereof.

### Tie Layer(s)

In some embodiments, the polymer substrate is a multilayer film that comprises one or more tie layers. The one or more tie layers are generally located intermediate the core layer and the one or more skin layers.

The tie layer may generally comprise any film-forming polymer, as described above. In some embodiments, the tie layer may comprise an adhesion promoting material such as a maleic anhydride modified polypropylene. An example of a suitable adhesion promoting material that is commercially available is ADMER™ AT1179A from Mitsui Chemicals America, Inc.

The thickness of the tie layer may be in the range of about 0.5 μm to 25 μm, or 1 μm to 12 μm, or preferably about 2 μm to 10 μm. In one embodiment, the thickness of the tie layer may be in the range of 0.5 μm to 8 μm, or 1 μm to 6 μm, or 1 μm to 4 μm.

The tie layer may further comprise one or more additives such as, for example, opacifying agents, pigments colorants, cavitating agents, slip agents, antioxidants, anti-fog agents, anti-static agents, anti-block agents, fillers, moisture barrier additives, gas barrier additives, and combinations thereof.

### Metallization

A metal coating layer is deposited on the outermost surface of the polymer substrate. In embodiments where the polymer substrate contains a metal receiving skin layer it is preferred that the metal coating layer is deposited on the outer surface of the metal receiving skin layer. Application of a metal coating layer may be accomplished by vacuum deposition, or any other metallization technique, such as electroplating or sputtering. The metal of the metal coating layer may be aluminum, or any other metal capable of being vacuum deposited, electroplated, or sputtered, such as, for example, gold, zinc, copper, or silver, chromium, or mixtures thereof. The thickness of the deposited metal coating may be in the range of about 5 to about 200 nanometers (nm), or in the range of about 10 to 100 nm, or in the range of about 30 to about 80 nm. In some embodiments, the metal layer is preferably less than about 0.1 wt % of the film structure.

It may be advantageous to treat the polymer substrate of the multilayered film structure of the present invention prior to receiving the metallized layer. Such treatment may enhance the adhesion of the metallized layer to the polymer substrate. A preferred treatment involves treating the surface to a surface tension level of at least about 35 dynes/cm, or preferably in the range of 38 to 45 dynes/cm, in accordance with ASTM D2578-84. The treatment can be flame treatment, plasma treatment, chemical treatment or corona discharge treatment, with flame treatment and corona discharge treatments being preferred. In some embodiments, the film may first be treated, for example by flame treatment, and then be treated again in the metallization chamber, for example by plasma treatment, immediately prior to being metallized

### Coating

The coated metallized multilayer film structure includes a topcoat layer. The topcoat layer protects the metal layer, thereby helping to retain not only the barrier properties of the metallized multilayer film structure but also the film's aesthetics. The topcoat layer may also provide a surface amenable to surface printing, add aesthetics to the film structure, provide sealing capability, or improve barrier properties. The topcoat layer may include, but is not limited to, acrylic coating, ethylene acrylic acid (“EAA”) coating, ethylene methacrylic acid (“EMA”) coating, acrylonitrile coating, polyvinylidene chloride (“PVdC”) coating, a polyvinyl alcohol (“PVOH”) coating, ethylene(vinyl)alcohol (“EVOH”), styrene-butadiene (“SBR”) coating, urethane coating, epoxy coating, or blends thereof. In some embodiments, a water-based coating is preferred.

The topcoat may comprise an acrylic coating, such as EMA, EAA, or acrylonitrile coatings. In one embodiment, the acrylic coating comprises a copolymer of 10 to 35 wt % of an α,β-ethylenically unsaturated carboxylic acid and 65 to 90 wt % of ethylene, an alkyl acrylate or methacrylate, acrylonitrile, or mixtures thereof. The unsaturated acid may be, for example, acrylic acid, methacrylic acid, maleic acid, crotonic acid, itaconic acid, citraconic acid, or mixtures thereof. The copolymer may have a number average molecular weight (Mn) in the range of about 2,000 to about 50,000, or in the range of about 4,000 to 10,000. For example, an EAA coating may comprise a copolymer of 65 to 90 wt %, or 75 to 85 wt %, of ethylene and 10 to 35 wt %, or 15 to 25 wt %, of acrylic acid, while an EMA coating may comprise 65 to 90 wt %, or 75 to 85 wt %, of ethylene and 10 to 35 wt %, or 15 to 25 wt %, of methacrylic acid.

In another embodiment, the acrylic coating may comprise a terpolymer of (1) 18 to 80 wt % of at least one C₁-C₄ alkyl methacrylate, (2) 18 to 80 wt % of at least one C₁-C₄ alkyl acrylate, and (3) 1 to 15 wt % of at least one α,β-ethylenically unsaturated carboxylic acid, based on the total weight of the terpolymer. The unsaturated acid may be, for example, acrylic acid, methacrylic acid, maleic acid, crotonic acid, itaconic acid, citraconic acid, or mixtures thereof.

In another embodiment, the acrylic coating contains a resin which consists essentially of an interpolymer of: (a) 2 to 15 parts by weight, or preferably 2.5 to 6 parts by weight, of an α,β-monoethylenically unsaturated carboxylic acid selected from the group consisting of acrylic acid, methacrylic acid and mixtures thereof; and (b) 85 to 98 parts by weight, or preferably 94 to 97.5 parts by weight, of neutral monomer esters which preferably include methyl acrylate or ethyl acrylate, and methyl methacrylate. These interpolymer compositions may be further characterized by including 30 wt % to 55 wt % of methyl methacrylate when the alkyl acrylate is methyl acrylate, or 52.5 wt % to 69 wt % of methyl methacrylate when the alkyl acrylate is ethyl acrylate. Such coating compositions can be applied to the multilayer film structure in a variety of ways, including ammoniac solutions.

In a further embodiment, the acrylic coating comprises a cationically stabilized emulsion polymer. The emulsion polymer may comprise at least one polymerizable monomer which is uncharged or positively charged in an aqueous solution having a pH between 1 and 8. The polymer may be polymerized in the presence of at least one water-soluble polymer having a number-average molecular weight greater than 5000 which comprises a moiety selected from the group consisting of primary amines, secondary amines, tertiary amines, and quaternary ammonium salts. An example of such an acrylic coating may be found in U.S. Pat. No. 6,596,379, incorporated herein by reference.

The topcoat may comprise a PVdC coating. The PVdC coating may have a vinylidene chloride content of at least 50%, or a vinylidene chloride content in the range of about 75% to about 99%. The PVdC coating may be a copolymer of vinylidene chloride and one or more other ethylenically unsaturated comonomers, such as α,β-ethylenically unsaturated acids or alkyl esters containing 1-18 carbon atoms of said acids, such as methyl methacrylate, ethyl methacrylate, butyl methacrylate. The PVdC coatings may comprise α,β-ethylenically unsaturated nitriles such as acrylonitrile and methacrylonitrile, and monovinyl aromatic compounds such as styrene and vinyl chloride comonomers.

PVdC coatings preferably include about 82% by weight of vinylidene chloride, about 14% by weight of ethyl acrylate, and about 4% by weight of acrylic acid. Alternatively, the PVdC coating may include about 80% by weight of vinylidene chloride, about 17% by weight of methyl acrylate, and about 3% by weight of methacrylic acid.

In one embodiment, the PVdC coating comprises (1) at least about 50 wt %, or 75 to 92 wt %, of vinylidene chloride, (2) 2 to 6 wt % of an α,β-ethylenically unsaturated carboxylic acid, and (3) the remainder being C₁-C₄ alkyl acrylate or methacrylate, or acrylonitrile. The unsaturated acid may be, for example, acrylic acid, methacrylic acid, maleic acid, crotonic acid, itaconic acid, citraconic acid, or mixtures thereof.

The topcoat layer may be a PVOH coating. In one embodiment, the PVOH coating comprises at least 98% hydrolyzed polyvinyl alcohol, or at least 99.3% super hydrolyzed polyvinyl alcohol.

In another embodiment, the PVOH coating comprises a blend of at least two PVOH resins having different degrees of hydrolysis. For example, the first component of the PVOH blend may have a high degree of hydrolysis of at least about 98% (i.e., about 98% of the acetate groups of the poly (vinyl acetate) have been replaced with alcohol (OH) groups) and the second component has a low degree of hydrolysis in the range of about 80% to 90%. The PVOH blend of the two components may be in a ratio of about 1:2 to about 20:1, or in the range of about 2:1 to about 5.1, or preferably in the range of about 2.5:1 to 3.5:1. In a preferred embodiment, the PVOH coating is an aqueous solution which includes a blend of at least two PVOH resins in an appropriate ratio to water at a temperature sufficient to dissolve the PVOH resin, a cross-linking agent, and optionally a catalyst.

The topcoat layer may be a urethane coating. Suitable urethane topcoat materials include copolymers of a glycol, a propanoic acid, and a polyisocyanate, for example a copolymer of a polybutylene glycol, a dimethylolpropionic acid, and isophorone diisocyanate, e.g. a copolymer of α-hydro-ω-hydroxypoly(oxy-1,4-butanediyl), 3-hydroxy-2-(hydroxymethyl)-2-methylpropanoic acid, and 5-isocyanato-1-(isocyanatomethyl)-1,3,3-trimethylcyclohexane.

In one embodiment, the topcoat is an epoxy coating. For example, the epoxy coating may be the reaction product of an epoxy resin and an acidified aminoethylated vinyl polymer, which is used as a hardener or curing agent. The epoxy resin may be glycidyl ethers of polyhydroxy compounds. Typical polyhydroxy compounds which may be used include bisphenol A, ring substituted bisphenol A, resorcinol, hydroquinone, phenol-formaldehyde, novolac resins, aliphatic diols, such as ethylene glycol, propylene glycol, 1,4-butanediol, 1,6-hexane-diol, glycerol, lower alkyl hydantoins, and mixtures thereof. For example, the epoxy resin may be made by the glycidation reaction between epichlorohydrin and bisphenol A. Epoxy resins of this type are commonly classified by their epoxy equivalent weight (“EEW”), which is defined as the weight of resin in grams which contains one gram equivalent of epoxy groups. Resins with an EEW in the range of 170 to 280, or in the range of 180 to 210 may be used.

The topcoat layer may include one or more additives. For example, the topcoat layer may further contain cross-linking agents, such as melamine formaldehyde resins. Cross-linking agents may be present in the topcoat layer in an amount of, for example, from 0 to about 20 parts by weight per hundred parts of the total topcoat layer.

The topcoat layer may impart added aesthetics to the present metallized multilayer film structure. In particular, the topcoat layer may be colored any desirable color by the addition of a coloring agent(s), such as a colored pigment or dye, to achieve a monoweb metallized film with a colored background, which may be especially useful for applications where an aluminum background behind the print is undesirable. By imparting a colored surface to the metallized multilayer film structure, these dyeing and pigmenting agents may obviate the need for a converter to put down 100% ink coverage of the desired background color.

In some embodiments, the multilayer film structure may further comprise a primer layer intermediate the metal layer and the topcoat layer. A primer may be useful in applications where even greater adherence is desired between the topcoat layer and the metal layer, i.e. greater than that which would result from surface-treatment alone of the metal layer. Before applying the primer the film may first be treated to provide increased active adhesion sites on the film's surface (thereby promoting primer adhesion). Then a continuous coating of a primer material may be applied to the surface treated film surface. The primer provides an overall adhesively active surface for thorough and secure bonding with the subsequently applied coating composition. The primer may be applied to the film by conventional solution methods, for example, by roller application.

Examples of useful primer materials are well known in the art and include, but are not limited to, acrylic coating, a styrene acrylic coating, an EAA coating, an EMA coating, a urethane coating, epoxy coating, and poly(ethylene imine) (“PEI”) coating, a polyester coating, and blends thereof.

In one embodiment, the primer coating layer may be a styrene acrylic coating. For example, the primer coating layer may be a copolymer containing up to 90 wt % of styrene, up to 80 wt % of an alkyl acrylate, up to 15 wt % of methacrylic acid, and from 5 wt % to 25 wt % of an acrylamide which has been condensed with a solution of formaldehyde in n-butanol containing from 0.2 to 3 equivalents of formaldehyde for each amide group in the copolymer. Another example of a styrene acrylic primer coating layer is a 50% solid solution of a copolymer resin containing 38.5 parts of styrene, 44 parts of ethyl acrylate, 2.5 parts of methacrylic acid and 15 parts of acrylamide which has been condensed with 5.2 parts of formaldehyde in n-butanol.

The primer coating layer may be poly(ethyleneimine), which is applied as either an aqueous or organic solvent, e.g. ethanol, solution, or as a solution in a mixture of water and organic solvent, containing from about 0.1 to about 0.6 wt % of the imine.

The primer coating layer may be a polyester coating layer, such as, for example, a linear, water-dissipatable polyester having an intrinsic viscosity of at least about 0.1 as measured in a 60-40 parts by weight solution of phenol/tetrachloroethane at 25° C., and at a concentration of 0.5 gram of polyester in 100 ml of solvent. The polyester may contain substantially equimolar proportions of acid moiety repeating units (100 mol %) to hydroxy moiety repeating units (100 mol %) and the polyester may comprise repeating units of components (a), (b), (c) and (d), as follows, wherein all stated mole percentages are based on the total of all acid and hydroxy moiety repeating units being equal to 200 mol %: (a) from about 90 mol % to about 97 mol % isophthalic acid; (b) from about 3 to about 10 mol % 5-sulfoisophthalic acid; (c) from about 70 to about 85 mol % 1,4-cyclohexanedimethanol; and (d) from about 15 to about 30 mol % diethylene glycol.

In some embodiments, it may be advantageous to include an alkaline buffering agent in the topcoat and/or primer used to coat the metallized surface. An alkaline buffering agent may prevent corrosion of the metallized surface by acidic components in the coatings. The small particles may provide corrosion protection with minimal impact on the metallic sheen of the metallized film. One example of a suitable commercially available alkaline buffering agent is Multiflex-MM, available from Specialty Minerals, Inc. New York, N.Y., which is an ultra-fine precipitated calcium carbonate. The alkaline buffering agent may be used at levels of up to 5 wt % of the dried coating.

Before applying either the topcoat or primer coating composition to the appropriate substrate, the outer surface of the film may be treated to increase its surface energy. For example, the metal layer may be surface treated prior to applying the topcoat or primer coating, although such treatment is typically not necessary due to the relatively high surface energy of freshly metallized surface. This treatment may help to ensure that the coating layer will be strongly adhered to the outer surface of the film, and thus reduce the possibility of the coating peeling or being stripped from the film. This treatment can be accomplished by employing known techniques, such as flame treatment, plasma, corona discharge, film chlorination, treatment with oxidizing agents such as chromic acid, hot air or steam treatment, and the like. A preferred method is corona discharge where the film surface is exposed to a high voltage corona discharge while passing the film between a pair of spaced electrodes. After surface treatment, the coating composition may then be applied thereto.

The coatings are preferably applied by an emulsion coating technique, but may also be applied by co-extrusion, and/or lamination. The coating composition may be applied to the film as a solution. For example, an aqueous or organic, e.g. ethanol, ketone, ester, etc., solvent solution may be used. However, since the coating can contain insoluble, finely divided inorganic materials which are difficult to keep well dispersed in organic solvents, it is preferable that the coating be applied in any other conventional manner, such as by rod, direct gravure coating (forward and reverse), offset gravure, slot die, air knife, roll coating, dipping, spraying, and the like. Alternatively, the coating can be 100% solids based, i.e. a solvent-less coating, which means that there is no solvent to dry off. Typically, a solvent-less coating may be cured via, for example, an electron beam-process.

The coating composition may be applied in such as amount so that there will be deposited upon drying a smooth, evenly distributed layer. The coating may be dried by hot air convection, electron beam, radiant heat (e.g., ultraviolet or microwave), or by any other conventional means. Generally, the coating composition is on the order of 0.1 μm to 5 μm in thickness, or in the range of about 0.381 μm to about 16.8 μm, or in the range of 0.31 g to 5.43 g of coating per square meter of film. For example, a PVOH coating may have a coating weight in the range of 0.5 g/m² to 1.6 g/m², while a coating in the range of 0.1 g/m² to 2.33 g/m² may be used for conventional acrylic and low temperature seal coatings, or in the range of 1.6 g/m² to 6.2 g/m² for conventional PVdC coatings.

### Orientation

The polymer substrate may be monoaxially or biaxially oriented. Orientation in the direction of extrusion is known as machine direction (“MD”) orientation. Orientation perpendicular to the direction of extrusion is known as transverse direction (“TD”) orientation. Orientation may be accomplished by stretching or pulling a film first in the MD followed by the TD. Orientation may be sequential or simultaneous, depending upon the desired film features. Preferred orientation ratios are commonly from between about three to about six times in the MD and between about four to about ten times in the TD.

Blown films may be oriented by controlling parameters such as take up and blow up ratio. Cast films may be oriented in the MD direction by take up speed, and in the TD through use of tenter equipment. Blown films or cast films may also be oriented by tenter-frame orientation subsequent to the film extrusion process, in one or both directions. Typical commercial orientation processes are BOPP tenter process and LISIM technology.

### INDUSTRIAL APPLICATION

The polymer substrate may be prepared by any suitable means. Preferred methods comprise co-extruding, then casting and orienting the multilayer film. In one embodiment, the polymer substrate may be formed by co-extruding the core layer, the tie layer(s), and the skin layer(s) together with any additional layers through a flat sheet extruder die at a temperature in the range of 200° C. to 260° C., casting the film onto a cooling drum and quenching the film. The sheet is then stretched 3 to 7 times its original size, in the machine direction (MD), followed by stretching 5 to 10 times its original size in the transverse direction (TD). The drawing temperature for the biaxial orientation may be in the range of about 100° C. to about 200° C. Optionally, one or both of the external surfaces may be flame treated or corona treated.

The multilayer metallized film structures disclosed herein have reduced water vapor transmission properties. The barrier properties of the disclosed films are preserved since the coating layer protects the metal layer from oxidation, thus making these films an excellent alternative to laminated aluminum films currently used in food packaging. The multilayer packaging structure may be printed, slit, laminated, or prepared for its final end use by other converting methods

In one embodiment, a method of preparing a multilayer film structure may comprise the steps of co-extruding at least: a core layer, a tie layer, and a skin layer, wherein the tie layer is intermediate the core layer and the skin layer to form a polymer substrate; metallizing the polymer substrate in a metallization chamber; removing the polymer substrate from said metallization chamber; and applying a topcoat to the metal layer within one (1) week, or within three (3) days, or within one (1) day of metallizing the polymer substrate. The method may further comprise the step of orienting the co-extruded polymer substrate in at least one direction.

In another embodiment, a method of preparing a multilayer film structure may comprise the steps of co-extruding at least a core layer, a tie layer, and a skin layer, wherein the tie layer is intermediate the core layer and the skin layer to form a polymer substrate; orienting said polymer substrate in at least one direction; metallizing the polymer substrate in a metallization chamber; removing the polymer substrate from said metallization chamber; storing said metallized film in an inert atmosphere; and applying a topcoat to the metal layer. The method may further comprise the steps of winding and/or slitting the metallized film before storing the metallized film in an inert atmosphere. The method may further comprise the step of removing said stored film and unwinding the metallized film before applying the topcoat to the metal layer.

The some embodiments, the method may further comprise the steps of enclosing a product or article within at least a portion of the film, engaging a first portion of the outer layer with a second portion of the outer layer at a seal area, and applying pressure and heat at the seal area, optionally for a determined duration of time, to cause the first portion to engage with the second portion to create at least one of a fin seal, a lap seal, and a crimp seal in the seal area.

In a preferred embodiment, the topcoat layer comprises a water-based coating. In another preferred embodiment, the primer comprises an alkaline buffering agent, such as, for example, calcium carbonate.

Applying the coating layer onto the metal layer outside of the metallization chamber is advantageous as it allows for the use of conventional coating equipment. Thus, it may provide cost savings and labor savings as compared to “in-chamber” coating methods. It also is a more flexible process, and allows the film to be wound, slit, cut, etc. before being coated. Furthermore, not all coatings can be applied in a vacuum chamber. Coating the metallized film after it has been removed from the metallization chamber allows for a wider-variety of coatings to be used.

For some applications, it may be desirable to produce the polymer substrate by a cast film or chill roll extrusion process rather than a coextrusion and orientation process. In this case, the final polymer substrate is essentially nonoriented and the final metallized film is generally much less stiff than films in which the polymer substrate is prepared by a coextrusion and orientation process.

### EXAMPLES

The coated metallized films will now be further described with reference to the following non-limiting examples. Uncoated metallized films and coated metallized films were prepared and the water vapor barrier properties of each film were measured at variable intervals in time from the date the film was metallized.

The water vapor transmission rate (“WTVR”) is the steady state rate at which water vapor permeates through a film at specified conditions of temperature and relative humidity. The water vapor transmission rate (“WVTR”) of each film was measured using a MOCON Permatran-W 3/32 at 38° C. and 90% relative humidity. The WVTR values are expressed in g/m²/24-hr. The metallized surface (coated or uncoated) of the film was exposed towards the moist driving force. The WVTR values reported in the Examples are the average of four samples measured during the age range indicated.

A listing of various components used in the Examples is in Table 1.

TABLE 1
Various Components Used in the Examples

| Component | Brief Description | Commercial Source |
|---|---|---|
| Metallyte ™ 100 Met-HB | Metallized, multilayer OPP film with a | ExxonMobil Chemical Company |
| | heat sealable layer. | |
| Metallyte ™ 28UBW-ES | Metallized multi-layer, cavitated, white | ExxonMobil Chemical Company |
| | OPP film with a heat sealable layer. | |
| Azcote 5800M | Ammonium zirconium carbonate | Hopton Technologies, Inc. |
| Hexyl Cellosolve ™ Solvent | Glycol ether solvent (ethylene glycol | Dow Chemical Company |
| | monohexyl ether). | |
| Michem ® Prime 4983.15 | Ethylene acrylic acid dispersion. | Michelman |
| Kosher | | |
| Mulitfex-MM ™ | Ultrafine/nano uncoated precipitated | Specialty Minerals Inc. |
| | calcium carbonate. | |
| R1117FP | Cationic Acrylic Emulsion | Owensboro Specialty Polymer, LLC |
| Tergitol ® 15-S-9 | Polyglycol ether surfactant. | Union Carbide Chemicals & Plastics |
| | | Technology Corp. |

### Example 1

WVTR measurements were made on six different sample films. These samples were checked periodically over a period of several months. Values reported in TABLE 2 are the average of four replicates made within the age range indicated.

Films 1 and 4 are samples of uncoated metallized base films. Base Film 1 is Metallyte™ 100 Met-HB and Base Film 2 is Metallyte™ 28UBW-ES, both available from ExxonMobil Chemical.

Films 2-3 and 5-6 comprise a base film, a primer, and a topcoat. Both Base Film 1 and 2 were metallized and slit and then shipped 240 miles to a location where they were coated with primer and topcoat the day after being metallized.

Primer A and Primer B are aqueous based primers which were applied to the metallized base films by reverse direct gravure process and then dried in a forced air oven at 180° C. Both primers had a target coating weight in the range of 0.10 to 0.15 g/msi (0.16 to 0.23 g/m²). Primer A was a blend of 10053 g tap water (for 11% solids); 27 g of Tergitol 15-S-9 (for 0.15%); 7920 g of MichemPrime 4983.15 (25% solids, 100 phr); and 90 g of Hexyl Cellosolve (0.5%) blended with overhead stirring in a 5-gallon pail. The Hexyl Cellosolve was added to enable the primer to wet out the metallized film without requiring in-line treatment. Primer B was a blend of 10095 g tap water (for 11% solids); 27 g of Tergitol 15-S-9 (for 0.15%); 151 g of Azcote 5800M (32% solids, 2.5 phr); 7720 g of MichemPrime 4983.15 (25% solids, 100 phr); and 90 g of Hexyl Cellosolve (0.5%) blended with overhead stirring in a 5-gallon pail. The MichemPrime 4983.15 was added last to the above blend to avoid the formation of grit.

After either Primer A or Primer B were applied to sample films 2-3 and 5-6, an aqueous based topcoat was applied on the primer layer. The topcoat was applied via reverse direct gravure process with a 175 fpm line speed. The 95-Quad gravure cylinder was running at 190 fpm in the opposite direction. After the topcoat was applied it was dried in a forced air oven at 210° F. (99° C.). The topcoat weight was between 0.5 and 0.6 g/msi (0.8 to 0.9 g/m²).

The topcoat was prepared at 10% solids. The topcoat formulation should be aged for at least four hours before being used. In the examples, topcoat was mixed the day before it was used. To form the topcoat, the following was mixed in a 2-gallon pail liner at 4000 rpm for five minutes with a Silverson High-Shear Mixer: 4000 g of tap water; 44 g (2.5 phr) of Multifex-MM (CaCO₃); and 18 g (half of 0.2% total) Tergitol 15-S-9. While the above dispersion was mixing, the following ingredients were dispersed in a lined 5-gallon pail with overhead stirring: 9174 g (for 10% solids) of tap water; 18 g (other half of 0.2% total) of Tergitoal 15-S-9; and 4746 g (100 phr) of R1117FP.

After the films were metallized and coated, they were allowed to age. The WVTR of each film was measured at various intervals of time with the values reported in TABLE 2. The percent reduction in relative WVTR rates was calculated relative to the initial WVTR values measured for each type of substrate as in the following Equation:

% Reduction=100×[(Reference WVTR−Sample WVTR)/Reference WVTR] Equation

For Films 1, 2, and 3, the Reference WVTR was 0.133 (the initial WVTR of Film 1, measured at 72-79 days). For Films 4, 5, and 6, the Reference WVTR was 0.073 (the initial WVTR of Film 4 measured at 37-44 days). For the % Reduction in Relative WVTR, larger positive values are desirable as this indicates a lower relative transmission rate of water vapor through the coated substrate (i.e., enhanced barrier properties). Due to variations in the uncoated substrate (such as normal manufacturing variations in metal thickness or random differences in defects due to slitting or other handling of the unprotected metallized surface), some relative transmission rates were negative values (i.e., less than zero), which is undesirable.

TABLE 2
WVTR and % Reduction in Relative VTR of Example 1 Sample Films

| | | | | | | % |
|---|---|---|---|---|---|---|
| | | | | | | Reduction |
| Sam- | | | | Age From | | in |
| ple | Base | | Top- | Metallization | WVTR | Relative |
| Film | Film | Primer | coat | (Days) | (g/m²/24-hr) | WVTR |
| 1 | 1 | None | None | 72-79 | 0.133 ± 0.010 | 0 |
| | | | | 141-142 | 0.160 ± 0.016 | −20 |
| | | | | 287 | 0.160 ± 0.026 | −20 |
| | | | | 339-340 | 0.125 ± 0.006 | 6 |
| 2 | 1 | A | I | 68-76 | 0.073 ± 0.013 | 45 |
| | | | | 135 | 0.058 ± 0.005 | 56 |
| | | | | 279-280 | 0.058 ± 0.015 | 56 |
| | | | | 332-333 | 0.050 ± 0.008 | 62 |
| 3 | 1 | B | I | 71-78 | 0.070 ± 0.000 | 53 |
| | | | | 136 | 0.055 ± 0.006 | 58 |
| | | | | 280-281 | 0.048 ± 0.005 | 64 |
| | | | | 333-336 | 0.045 ± 0.006 | 66 |
| 4 | 2 | None | None | 37-44 | 0.073 ± 0.015 | 0 |
| | | | | 108-109 | 0.023 ± 0.005 | −20 |
| | | | | 305-306 | 0.038 ± 0.005 | 48 |
| 5 | 2 | A | I | 36-43 | 0.050 ± 0.022 | 32 |
| | | | | 103 | 0.033 ± 0.010 | 55 |
| | | | | 301-302 | 0.020 ± 0.010 | 73 |
| 6 | 2 | B | I | 38-45 | 0.033 ± 0.010 | 55 |
| | | | | 106-107 | 0.023 ± 0.005 | 68 |
| | | | | 303-305 | 0.020 ± 0.000 | 73 |

For both types of base films, coating the freshly metallized film yielded a net 58±11% reduction in the WVTR when compared with the uncoated metallized substrate. These reductions were obtained even after the base film was removed from the metallizer, slit, and shipped by truck nearly 240 miles. Thus, even better barrier enhancements might be obtained if the slitting step between metallization and coating could be eliminated. These WVTR enhancements persisted for more than 300 days without showing any sign of degradation, suggesting that coating the metallized film with a water-based coating halted the conversion of aluminium to aluminium oxide.

Improvements in the barrier properties of the sample films were seen even though an acrylic coating was used. Acrylic coatings are not generally known to give enhanced barrier properties, thus it was surprising that coating the freshly metallized film with an acrylic coating gave such improved barrier properties. Even more improved barrier properties might be obtained using the method if a topcoat such as PVdC, which is known for improving barrier properties, was used.

### Example 2

Material was retained from the same roll of Base Film 1 used in Example. The film was coated (with Primer A and topcoat as in Example 1) 35 days after the base film was initially metallized and slit to form Sample 8. The WVTR of each film was measured, with the values reported in Table 3. Only two replicates were tested for each sample, but the mean value was within one standard deviation of the initial measurements, as were coated and uncoated samples. The % Reduction in Relative WVTR was calculated as in Example 1, with the Reference WVTR for Films 7 and 8, being 0.11 (the WVTR of Film 7, measured at 49 days).

TABLE 3
WVTR and % Reduction in Relative WVTR of Example 2 Sample Films

| Sam- | | | | Age From | | % Reduction |
|---|---|---|---|---|---|---|
| ple | Base | | Top- | Metallization | WVTR | in Relative |
| Film | Film | Primer | coat | (Days) | (g/m²/24-hr) | WVTR |
| 7 | 1 | None | None | 49 | 0.12 ± 0.02 | 0 |
| 8 | 1 | A | I | 42 | 0.11 ± 0.02 | 8 |

As seen in Table 3, coating the metallized base film that was more than a month old did not yield a significant barrier enhancement. Film 8 had the same composition of Film 2 from Example 1, except that Film 2 was coated the day after metallization; however, Film 2 exhibited a better WVTR than Film 8 (even after several months of testing). It is believed that, after a month oxygen and moisture had sufficiently penetrated into the metallized roll to convert all accessible aluminium to aluminium oxide. Thus, in order to obtain improved WVTR, the coating should be applied to the metal layer as soon as possible after the film is removed from the metallization chamber.

### Example 3

In Example 3 laminations were made with coated metallized films. Table 4 lists the WVTR for the unlaminated flat-sheet barrier (i.e., the coated metallized film) at 100% relative humidity, with the metallized surface (coated or uncoated) facing towards the moist driving force. The same roll of the base film was used to form all 3 of the sample films.

TABLE 4
Coated Metallized Film WVTR

| Sample | Base | | | WVTR (g/m²/24-hr) |
|---|---|---|---|---|
| Film | Film | Primer | Topcoat | at 100% RH |
| 9 | 2 | None | None | 0.27; 5.57; 6.33; 6.16 |
| 10 | 2 | EAA/5 phr AZC | R1117FP | 0.03; 0.03; 0.04; 0.08 |
| 11 | 2 | EAA/10 phr AZC | R1117FP | 0.05; 0.04 |

The sample films from Table 4 were used to form adhesive laminations to paper. The laminations were prepared and were tested for WVTR at 100% relative humidity, with the with the metallized surface (coated or uncoated) facing towards the moist driving force, see Table 5.

TABLE 5
Paper Laminate With Coated Metallized Film

| Laminated | Primary | | WVTR (g/m²/24-hr) at |
|---|---|---|---|
| Film | Web | Secondary Web | 100% RH |
| 1 | Sample | 28# Paper | 0.49; 8.42 |
| | Film 9 | | |
| 2 | Sample | 28# Paper | 0.06; 0.007 |
| | Film 10 | | |
| 3 | Sample | 28# Paper | 0.08; 0.10 |
| | Film 11 | | |

The EAA primer which was cross-linked with AZC, allowed laminations made with the coated Base Film 2 and paper (i.e., Laminated Films 2 and 3) to show robust barrier properties adhesive laminations. Laminations containing the uncoated metallized film (i.e., Laminated Film 1) did not exhibit good barrier properties. This indicates that it is very easy to damage the metallized film during the lamination process, which in turn reduces the films barrier properties. Treatment of the metallized film during the coating process had no significant impact on WVTR.

All patents and patent applications, test procedures (such as ASTM methods, UL methods, and the like), and other documents cited herein are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The invention has been described above with reference to numerous embodiments and specific examples. Many variations will suggest themselves to those skilled in this art in light of the above detailed description. All such obvious variations are within the full intended scope of the appended claims.

1. A method of preparing a film comprising the steps of:
a) providing a polymer substrate;
b) depositing a metal layer on the polymer substrate in a metallization chamber;
c) removing the metallized film from the metallization chamber; and
d) applying a topcoat to said metal layer;
wherein step (d) occurs within 1 week of step (b).

2. The method of claim 1, wherein step (d) occurs within a time period from step (b), the time period being selected from the group consisting of three (3) days, one (1) day, 12 hours, six (6) hours, three (3) hours, one (1) hour, 30 minutes.

3. The method of claim 1, further comprising the step of treating the outer surface of the polymer substrate or metal layer with at least one treatment selected from one of corona discharge, flame treatment, plasma treatment, chemical treatment, and treatment by means of a polarized flame.

4. The method of claim 1, further comprising the step of storing the metallized film in an inert atmosphere prior to applying the coating.

5. The method of claim 4, wherein said inert atmosphere has an oxygen content selected from less than 20.9% oxygen, less than 17% oxygen, less than 15% oxygen, less than 10% oxygen, and less than 5% oxygen.

6. The method of claim 1, wherein the topcoat comprises at least one of ethylene acrylic acid, ethylene methyl acrylate copolymers, polyvinylidene chloride, polyvinyl alcohol, and ethyl vinyl alcohol.

7. The method of claim 1, wherein the topcoat is a water-based coating.

8. The method of claim 1, further comprising the step of applying a primer to said metal layer prior to applying said topcoat.

9. The method of claim 8, wherein said primer comprises an alkaline buffering agent.

12. A film made by the process of:
a) providing a polymer substrate;
b) depositing a metal layer on the polymer substrate in a metallization chamber;
c) removing the metallized film from the metallization chamber; and
d) applying a topcoat to said metal layer;
wherein steps (d) occurs within one (1) week of step (b).

13. The film of claim 12, wherein step (d) occurs within a time period from step (b), the time period being selected from the group consisting of three (3) days, one (1) day, 12 hours, six (6) hours, three (3) hours, one (1) hour, 30 minutes.

14. The film of claim 12, wherein the topcoat comprises at least one of ethylene acrylic acid, ethylene methyl acrylate copolymers, polyvinylidene chloride, polyvinyl alcohol, and ethyl vinyl alcohol.

15. The film of claim 12, wherein the metal layer is deposited on the polymer substrate by vacuum deposition of aluminum.

16. The film of claim 12, wherein providing the polymer substrate comprises the steps of:
i. co-extruding a core layer and at least one skin layer; and
ii. orienting the co-extruded film in at least one direction.

17. The film of claim 12, wherein said film has a water-vapor transmission rate that is 30% less than the WVTR of a coated metallized film that was coated more than 30 days after being metallized.

18. A multilayered film structure comprising:
a) a polymer substrate;
b) a metal layer; and
c) a topcoat;
wherein said film has a water-vapor transmission rate that is 80% or less than the water-vapor transmission rate of a film comprising said polymer substrate and said metal layer.

19. (canceled)

20. The film of claim 18, wherein the topcoat comprises at least one of ethylene acrylic acid, ethylene methyl acrylate copolymers, polyvinylidene chloride, polyvinyl alcohol, and ethyl vinyl alcohol.

21. The film of claim 18, wherein the metal layer comprises 40% or less aluminum oxide.

22. A method of preparing a film comprising the steps of:
a) providing a polymer substrate;
b) depositing a metal layer on the polymer substrate in a metallization chamber;
c) removing the metallized film from the metallization chamber;
d) storing the metallized film in an inert atmosphere; and
e) applying a topcoat to said metal layer.

23. The method of claim 22, wherein said inert atmosphere has an oxygen content selected from less than 20.9% oxygen, less than 17% oxygen, less than 15% oxygen, less than 10% oxygen, and less than 5% oxygen.
